(19) United States
(12) Patent Application Publication
(10) Pub. No.: US 2014/0206244 A1
(43) Pub. Date: Jul. 24, 2014

(54) FEMALE TERMINAL

(71) Applicant: YAZAKI CORPORATION, Tokyo (JP)

(72) Inventor: Hajime KATO, Kakegawa-shi (JP)

(73) Assignee: YAZAKI CORPORATION, Tokyo (JP)

(21) Appl. No.: 14/219,265

(22) Filed: Mar. 19, 2014

Related U.S. Application Data
(63) Continuation of application No. PCT/JP2012/006148, filed on Sep. 26, 2012.

(30) Foreign Application Priority Data
Sep. 27, 2011 (JP) 2011-210866

(51) Int. Cl. H01R 4/18

(52) U.S. Cl. CPC H01R 4/18
USPC 439/878

(57) ABSTRACT

A female terminal includes a terminal connection portion for a male terminal to be inserted and an electric wire connection portion for connection with an electric wire to be electrically connected to the male terminal. The electric wire connection portion is formed independently of the terminal connection portion and has a thickness greater than a thickness of the terminal connection portion. The terminal connection portion is provided along a surface extending in an insertion direction of the male terminal to be inserted into the terminal connection portion and includes a fixing portion for the electric wire connection portion to be fixed.

### CROSS REFERENCE TO RELATED APPLICATION

This application is a Continuation of PCT Application No. PCT/JP2012/006148, filed on Sep. 26, 2012, and claims the priority of Japanese Patent Application No. 2011-210866, filed on Sep. 27, 2011, the content of both of which is incorporated herein by reference.

### BACKGROUND

1. Technical Field

The present invention relates to a female terminal electrically connected to a male terminal.

2. Related Art

Japanese Patent Application Laid-Open No. 2002-100430 and Japanese Patent Application Laid-Open No. 2011-44256 propose technologies concerning a female terminal electrically connected to a male terminal.

This type of female terminal includes a terminal connection portion and an electric wire connection portion. The male terminal is inserted into the terminal connection portion. The electric wire connection portion is crimped to an electric wire that is electrically connected to the male terminal. The terminal connection portion contains an elastic contact member contactable with the male terminal.

The elastic contact member is formed as one or more elastic contact pieces cantilevered at one side of an insertion direction for the male terminal. Punching the same base material integrally forms the terminal connection portion and the electric wire connection portion.

Generally, the base material is shaped into a thin plate. The electric wire connection portion is deformed and crimped to an electric wire periphery so that the electric wire connection portion covers the electric wire periphery. The electric wire is thereby fastened to the electric wire connection portion.

### SUMMARY

According to the above-mentioned female terminal, however, the electric wire connection portion is shaped into a thin plate and is considerably deformed after it is crimped around the electric wire periphery. Durability of the electric wire connection portion is not always ensured.

To ensure the durability of the electric wire connection portion, a possible solution may be to vary a pressure applied to the base material during punching and increase the thickness corresponding to the electric wire connection portion. However, an extra process is needed to previously specify the position corresponding to the electric wire connection portion on the base material. The base material is used wastefully. As a result, manufacturing costs increase.

The present invention aims at providing a female terminal capable of improving durability of an electric wire connection portion without increasing manufacturing cost.

A female terminal in accordance with some embodiments including: a terminal connection portion for a male terminal to be inserted, the terminal connection portion being provided along a surface extending in an insertion direction of the male terminal to be inserted into the terminal connection portion; and an electric wire connection portion for connection with an electric wire to be electrically connected to the male terminal, the electric wire connection portion being formed independently of the terminal connection portion and having a plate shape with a thickness greater than a thickness of a base material of the terminal connection portion. The terminal connection portion includes a fixing portion for the electric wire connection portion to be fixed.

According to the configuration, an electric wire connection portion is formed independently of the terminal connection portion and has a thickness greater than a thickness of the terminal connection portion. Suppose a case where the electric wire connection portion is made of a base material whose thickness equals that of the terminal connection portion (thin plate). Unlike this case, durability of the electric wire connection portion can be improved even if the electric wire connection portion is crimped around an electric wire and is considerably deformed.

A fixing portion is fixed to the electric wire connection portion. Therefore, the terminal connection portion and the electric wire connection portion can be fixed without changing a force applied to the base material during punching. There is no need to previously specify a position corresponding to the electric wire connection portion on the base material. The base material is no used wastefully. As a result, manufacturing cost of the female terminal does not increase.

The terminal connection portion may include a box-shaped body portion and an elastic contact member built into the body portion and being contactable with the male terminal, and the fixing portion may be formed integrally with the body portion or the elastic contact member.

According to the configuration, the fixing portion is formed integrally with one of the body portion and the elastic contact member. Suppose a case where the fixing portion is formed independently of the body portion or the elastic contact member. Unlike this case, there is no need for a procedure to attach the fixing portion to the body portion or the elastic contact member. Manufacturing cost of the female terminal can be further reduced.

The electric wire connection portion may include: a bottom portion for positioning a core of the electric wire; and a crimping portion continuous with the bottom portion and raised from the bottom portion, and the fixing portion may protrude toward the electric wire connection portion and have a contact surface configured to contact with a surface of the bottom portion located inward of the crimping portion.

According to the configuration, the fixing portion includes a contact surface. This can enlarge a contacting area between the fixing portion and the electric wire connection portion and increase anchorage strength between them.

The fixing portion may include: a connection portion continuous with a surface extending in the insertion direction of the male terminal to be inserted into the terminal connection portion; and a wide end portion positioned at a tip of the connection portion and formed wider than the connection portion in a direction orthogonal to the insertion direction of the male terminal.

According to the configuration, the fixing portion includes a wide end portion. This can further enlarge a contacting area between the fixing portion and the electric wire connection portion and increase anchorage strength between them.

The fixing portion and the electric wire connection portion may be indented.

According to the configuration, the fixing portion and the electric wire connection portion are indented. Suppose a case where the fixing portion and the electric wire connection portion are formed flat. Unlike this case, the configuration can further enlarge a contacting area between the fixing portion and the electric wire connection portion and increase anchorage strength between them.

In addition, the indented surface of the fixing portion engages with that of the electric wire connection portion. Even an external vibration (e.g., vehicle vibration) hardly causes slippage between the fixing portion and the electric wire connection portion. This can further increase anchorage strength between the fixing portion and the electric wire connection portion. In addition, an electric wire crimped by the electric wire connection portion more reliably stays unmoving in the terminal connection portion. This can also improve reliability of connection between a male terminal and the elastic contact member conductively connected to the electric wire.

The electric wire connection portion may include a fitting dent portion formed by denting from a surface of the electric wire connection portion and configured to fit to the fixing portion.

According to the configuration, the fitting dent portion is formed in the electric wire connection portion so that the fixing portion fits into the fitting dent portion. Even an external vibration (e.g., vehicle vibration) hardly causes slippage between the fixing portion and the electric wire connection portion. This can further increase anchorage strength between the fixing portion and the electric wire connection portion. In addition, an electric wire crimped by the electric wire connection portion more reliably stays unmoving in the terminal connection portion. This can also improve reliability of connection between a male terminal and the elastic contact member conductively connected to the electric wire.

The fixing portion may include an insertion hole, the electric wire connection portion may include a projection portion protruding from a surface of the electric wire connection portion, the projection portion being to be inserted into the insertion hole and thereafter be deformed at a tip thereof to fix the fixing portion to the electric wire connection portion.

According to the configuration, the projection portion is inserted into the insertion hole and then is deformed at the tip. The fixing portion is thereby fixed to the electric wire connection portion. The projection portion is hardly removed from the insertion hole in an extending direction along the projection portion. The configuration can ensure anchorage strength between the fixing portion and the electric wire connection portion.

The fixing portion may include an edge portion protruding from the terminal connection portion nearest to the electric wire connection portion, and the edge portion may be fixed to an edge of the electric wire connection portion through solid-phase bonding or welding.

According to the configuration, the edge portion is fixed to the electric wire connection portion through solid-phase bonding or welding. This can minimize the amount of fixing portion protruding from the terminal connection portion and save the base material for the fixing portion. The configuration can further reduce manufacturing cost of the female terminal.

The embodiments of the present invention can provide a female terminal capable of improving durability of an electric wire connection portion without increasing manufacturing cost.

### BRIEF DESCRIPTION OF DRAWINGS

FIG. 1A is a perspective view illustrating a female terminal according to a first embodiment.

FIG. 1B is a cross sectional view taken along the line IB-IB of FIG. 1A.

FIG. 2A is a perspective view illustrating the female terminal according to the first embodiment.

FIG. 2B is a cross sectional view taken along the line IIB-IIB of FIG. 2A.

FIG. 3A is a front view illustrating the female terminal according to the first embodiment.

FIG. 3B is a cross sectional view taken along the line IIIB-IIIB of FIG. 3A.

FIG. 3C is a cross sectional view taken along the line IIIC-IIIC of FIG. 3A.

FIG. 4A is a perspective view illustrating a female terminal according to a second embodiment.

FIG. 4B is a partly developed plan view.

FIG. 5A is a perspective view illustrating a disassembled state of only a fixing portion and an electric wire connection portion according to a second embodiment.

FIG. 5B is a perspective view illustrating an assembled state of the fixing portion and the electric wire connection portion according to the second embodiment.

FIG. 5C is a perspective view illustrating a bent state of the fixing portion and the electric wire connection portion according to the second embodiment.

FIG. 6A is a cross sectional view taken along the line VIA-VIA of FIG. 5A.

FIG. 6B is a cross sectional view taken along the line VIB-VIB of FIG. 5B.

FIG. 6C is a cross sectional view taken along the line VIC-VIC of FIG. 5C.

FIG. 7A illustrates FIG. 6A viewed from the arrow E′. FIG. 7B illustrates FIG. 6B viewed from the arrow F′.

FIG. 7C illustrates FIG. 6C viewed from the arrow G′.

FIG. 8 is a perspective view illustrating a female terminal according to a modification of the second embodiment.

FIG. 9A is a perspective view illustrating a disassembled state of only a fixing portion and an electric wire connection portion according to the second embodiment.

FIG. 9B is a perspective view illustrating an assembled state of the fixing portion and the electric wire connection portion according to the second embodiment.

FIG. 9C is a perspective view illustrating a bent state of the fixing portion and the electric wire connection portion according to the second embodiment.

FIG. 10A is a cross sectional view taken along the line XA-XA of FIG. 9A.

FIG. 10B is a cross sectional view taken along the line XB-XB of FIG. 9B.

FIG. 10C is a cross sectional view taken along the line XC-XC of FIG. 9C.

FIG. 11A illustrates FIG. 10A viewed from the arrow H′.

FIG. 11B illustrates FIG. 10B viewed from the arrow I′.

FIG. 11C illustrates FIG. 10C viewed from the arrow J′.

FIG. 12A is a perspective view illustrating a female terminal according to a third embodiment.

FIG. 12B is a disassembled perspective view.

FIG. 13A is a cross sectional view taken along the line XIIIA-XIIIA of FIG. 12A.

FIG. 13B is a cross sectional view taken along the line XIIIB-XIIIB of FIG. 12B.

### DETAILED DESCRIPTION

The following describes the female terminal according to embodiments of the invention with reference to the accompanying drawings. Specifically, (1) first embodiment, (2) second embodiment, (3) third embodiment, and (4) other embodiments will be described.

Throughout the drawing, the same or similar elements when shown in more than one figure are designated by the same or similar reference numerals. It should be noted that the drawing is schematic and dimensional ratios may differ from actual values.

Therefore, the following description needs to be taken into consideration in estimating specific dimensions. Dimensional relations and ratios may differ between figures.

### (1) First Embodiment

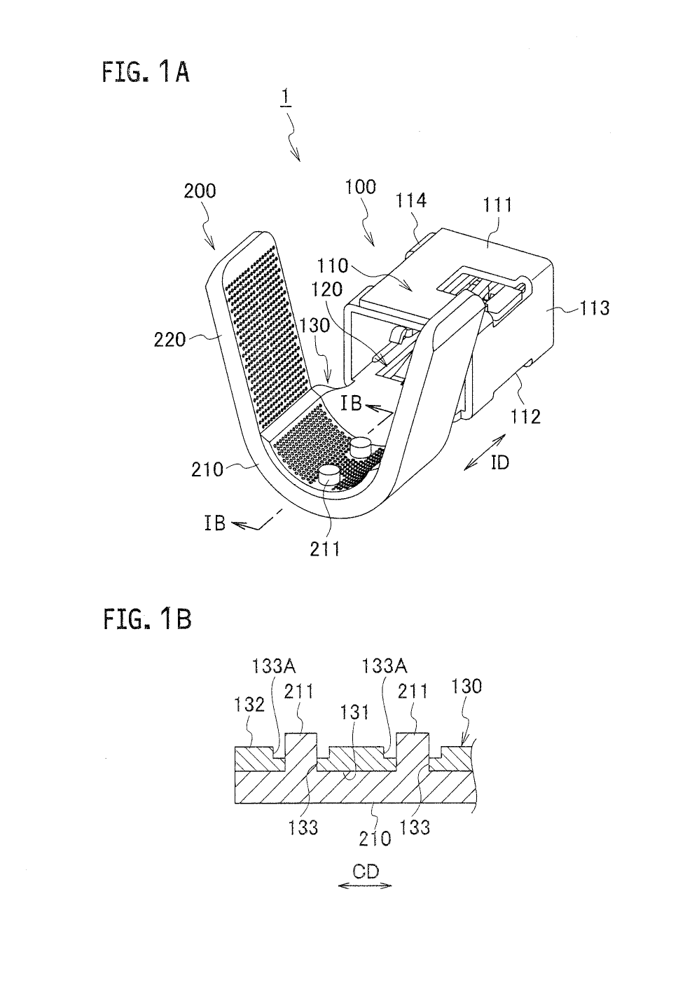

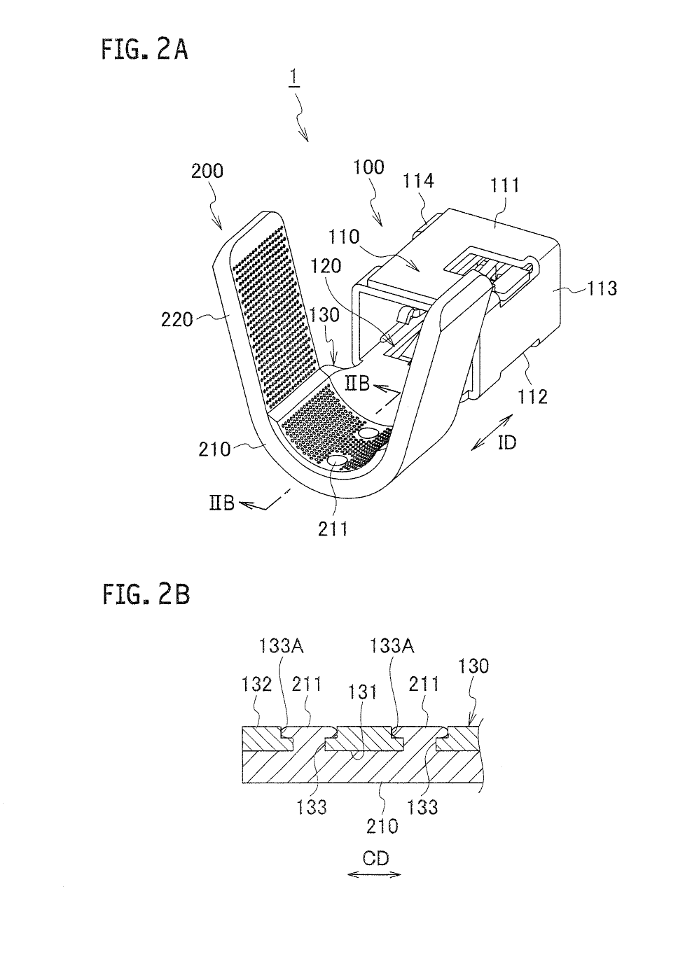

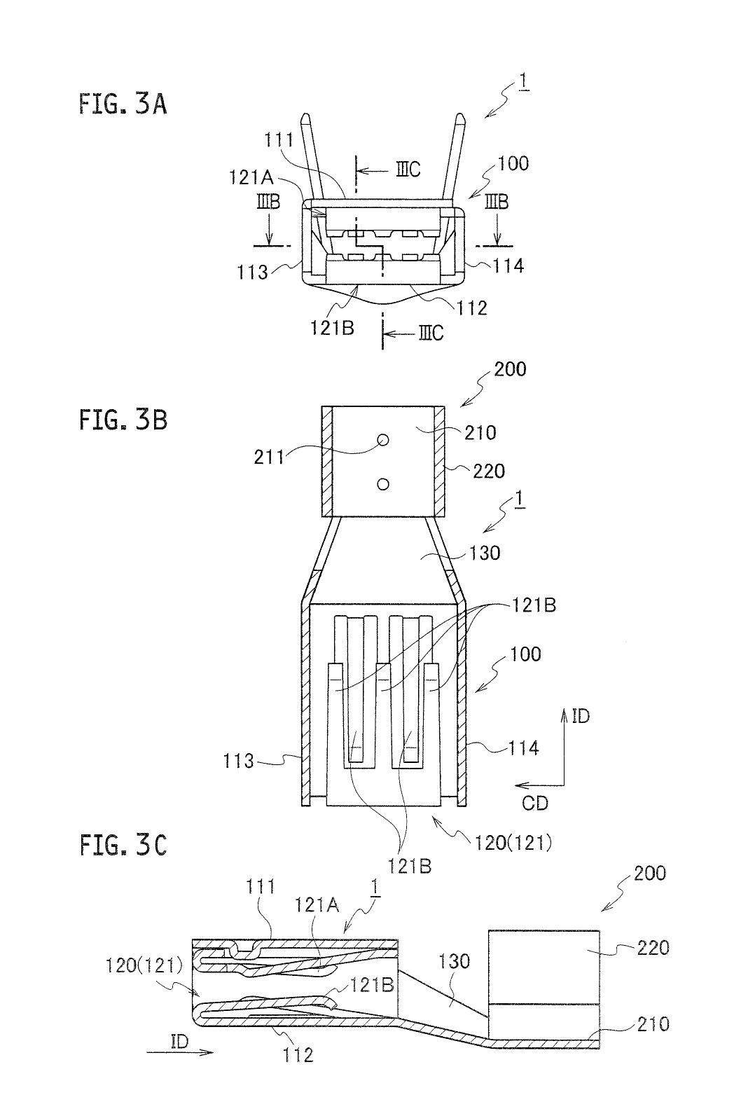

The configuration of a female terminal according to the first embodiment will be described with reference to the accompanying drawings. FIG. 1A is a perspective view illustrating a female terminal 1 according to the first embodiment (before modification of a projection portion 211). FIG. 1B is a cross sectional view taken along the line IB-IB of FIG. 1A. FIG. 2A is a perspective view illustrating the female terminal 1 according to the first embodiment (after modification of a projection portion 211). FIG. 2B is a cross sectional view taken along the line IIB-IIB of FIG. 2A. FIG. 3A is a front view illustrating the female terminal 1 according to the first embodiment. FIG. 3B is a cross sectional view taken along the line IIIB-IIIB of FIG. 3A. FIG. 3C is a cross sectional view taken along the line IIIC-IIIC of FIG. 3A. The female terminal 1 according to the first embodiment holds a high-voltage electrical power line used for a vehicular electric system and is electrically connected to a male terminal (not shown).

### (1.1) Configuration of the Female Terminal 1

As illustrated in FIGS. 1A to 3C, the female terminal 1 includes a terminal connection portion 100 and an electric wire connection portion 200. A male terminal is inserted into the terminal connection portion 100. The electric wire connection portion 200 connects with an electric wire (not shown) electrically connected to the male terminal.

The terminal connection portion 100 includes a body portion 110 and an elastic contact member 120. The elastic contact member 120 is built into the body portion 110 and is contactable with a male terminal.

The body portion 110 is shaped into a rectangular box surrounded by a top surface 111, a bottom surface 112, and side surfaces 113 and 114 along insertion direction ID for a male terminal to be inserted. An elastically deformable elastic contact member 120 is provided for each of the top surface 111 and the bottom surface 112 of the terminal connection portion 100.

As illustrated in FIGS. 3A to 3C, the elastic contact member 120 is formed of one or more elastic contact pieces 121 that are cantilevered at one end of the male terminal in the insertion direction ID. Inserting the male terminal into the body portion 110 elastically deforms the elastic contact piece 121 that then contacts with the male terminal due to a restoring force. That is, the male terminal is sandwiched between an elastic contact piece 121A provided for the top surface 111 and an elastic contact piece 121B provided for the bottom surface 112. The elastic contact member 120 thereby contacts with the male terminal. According to the first embodiment, the elastic contact member 120 and the body portion 110 are formed integrally with each other.

The terminal connection portion 100 includes a fixing portion 130 to which the electric wire connection portion 200 is fixed. The fixing portion 130 will be described in detail later.

The electric wire connection portion 200 is crimped to fasten an electric wire (not shown) that is electrically connected to the male terminal. The electric wire connection portion 200 may fasten an electric wire by welding.

The electric wire connection portion 200 is formed separately from the terminal connection portion 100. The electric wire connection portion 200 is formed into a plate. The electric wire connection portion 200 is thicker (e.g., 2.0 mm) than the terminal connection portion 100 (e.g., 0.8 mm, the thickness of the base material).

The electric wire connection portion 200 includes a bottom portion 210 and a crimping portion 220. The bottom portion 210 positions a core (not shown) of the electric wire. The crimping portion 220 is continuous with the bottom portion 210. The crimping portion 220 is bent and raised from the bottom portion 210 to crimp the electric wire core and coating material. The crimping portion 220 is bent and crimped to fold the electric wire positioned at the bottom portion 210. The electric wire can be thereby fastened to the bottom portion 210.

Surfaces of the bottom portion 210 and the crimping portion 220 are indented like serrations along the male terminal insertion direction ID. The outward (upward) protruding projection portion 211 is formed on the surface of the bottom portion 210. The projection portion 211 is formed at the center of the bottom portion 210 in an orthogonal direction CD orthogonal to the male terminal insertion direction ID.

### (1.2) Configuration of the Fixing Portion

As illustrated in FIGS. 1A to 3C, the fixing portion 130 is provided along the surface (bottom surface 112) extending in the male terminal insertion direction ID. In other words, the bottom surface 112 extends (protrudes) toward the electric wire connection portion 200 to form the fixing portion 130. That is, the fixing portion 130 is formed integrally with the body portion 110. The fixing portion 130 has an approximately constant width in the orthogonal direction CD orthogonal to the male terminal insertion direction ID. The fixing portion 130 is bent together with the electric wire connection portion 200.

The fixing portion 130 is fixed to the bottom portion 210 of the electric wire connection portion 200. As illustrated in FIGS. 1B and 2B, the fixing portion 130 has a contact surface 131 that contacts with the surface of the bottom portion 210 located inward of the crimping portion 220. The contact surface 131 and a surface 132 on the back of the contact surface 131 are indented like serrations along the male terminal insertion direction ID (see FIGS. 1A and 2A).

As illustrated in FIGS. 1B and 2B, an insertion hole 133 is formed in the fixing portion 130. The insertion hole 133 pierces through the fixing portion 130 from the contact surface 131 to the surface 132. The projection portion 211 formed on the bottom portion 210 is inserted into the insertion hole 133. The insertion hole 133 is provided with an enlarged portion 133A on the surface 132.

As illustrated in FIGS. 1A and 1B, the projection portion 211 is inserted into the insertion hole 133. As illustrated in FIGS. 2A and 2B, the tip of the projection portion 211 is deformed (pressed) toward the bottom. As illustrated in FIG. 2B, the tip of the projection portion 211 spreads in the enlarged portion 133A to fasten the fixing portion 130 on the electric wire connection portion 200.

Bending the electric wire connection portion 200 (bottom portion 210 and crimping portion 220) also bends the fixing portion 130. The fixing portion 130 is thereby bent and curved on the surface of the bottom portion 210. According to the first embodiment, the fixing portion 130 is fixed to the electric wire connection portion 200 before bending.

### (1.3) Operation and Effect

According to the first embodiment, the electric wire connection portion 200 is formed independently of the terminal connection portion 100. The plate-like electric wire connection portion 200 is thicker than the terminal connection portion 100. Suppose a case where the electric wire connection portion 200 is made of a base material whose thickness equals that of the terminal connection portion 100 (thin plate). Unlike this case, the first embodiment can improve durability of the electric wire connection portion 200 even if the electric wire connection portion 200 is crimped around an electric wire and is considerably deformed.

The fixing portion 130 is fixed to the electric wire connection portion 200. Therefore, the terminal connection portion 100 and the electric wire connection portion 200 can be fixed without changing a force applied to the base material during punching. There is no need to previously specify a position corresponding to the electric wire connection portion 200 on the base material. The base material is no used wastefully. As a result, manufacturing cost of the female terminal 1 does not increase.

According to the first embodiment, the fixing portion 130 is formed integrally with the body portion 110 (bottom surface 112). Suppose a case where the fixing portion 130 is formed independently of the body portion 110. Unlike this case, the first embodiment eliminates the need for a procedure to attach the fixing portion 130 to the body portion 110. The embodiment can further reduce manufacturing cost of the female terminal 1.

According to the first embodiment, the fixing portion 130 includes the contact surface 131. This can enlarge a contacting area between the fixing portion 130 and the electric wire connection portion 200 and increase anchorage strength between them.

According to the first embodiment, the fixing portion 130 and the electric wire connection portion 200 are indented. Suppose a case where the fixing portion 130 and the electric wire connection portion 200 are formed flat. Unlike this case, the first embodiment can further enlarge a contacting area between the fixing portion 130 and the electric wire connection portion 200 and increase anchorage strength between them.

In addition, the indented surface of the fixing portion 130 engages with that of the electric wire connection portion 200. Even an external vibration (e.g., vehicle vibration) hardly causes slippage between the fixing portion 130 and the electric wire connection portion 200. This can further increase anchorage strength between the fixing portion 130 and the electric wire connection portion 200. In addition, an electric wire crimped by the electric wire connection portion 200 more reliably stays unmoving in the terminal connection portion 100. This can also improve reliability of connection between a male terminal and the elastic contact member 120 conductively connected to the electric wire.

According to the first embodiment, the projection portion 211 is inserted into the insertion hole 133 and then is deformed at the tip. The fixing portion 130 is thereby fixed to the electric wire connection portion 200. The projection portion is hardly removed from the insertion hole in an extending direction along the projection portion. The first embodiment can ensure anchorage strength between the fixing portion 130 and the electric wire connection portion 200.

### (2) Second Embodiment

The configuration of a female terminal 2 according to the second embodiment will be described with reference to the accompanying drawings. The same reference numerals are used for the mutually corresponding parts in the female terminal 2 and the female terminal 1 according to the first embodiment. The description below mainly discloses differences from the first embodiment.

### (2.1) Configuration of the Female Terminal 2

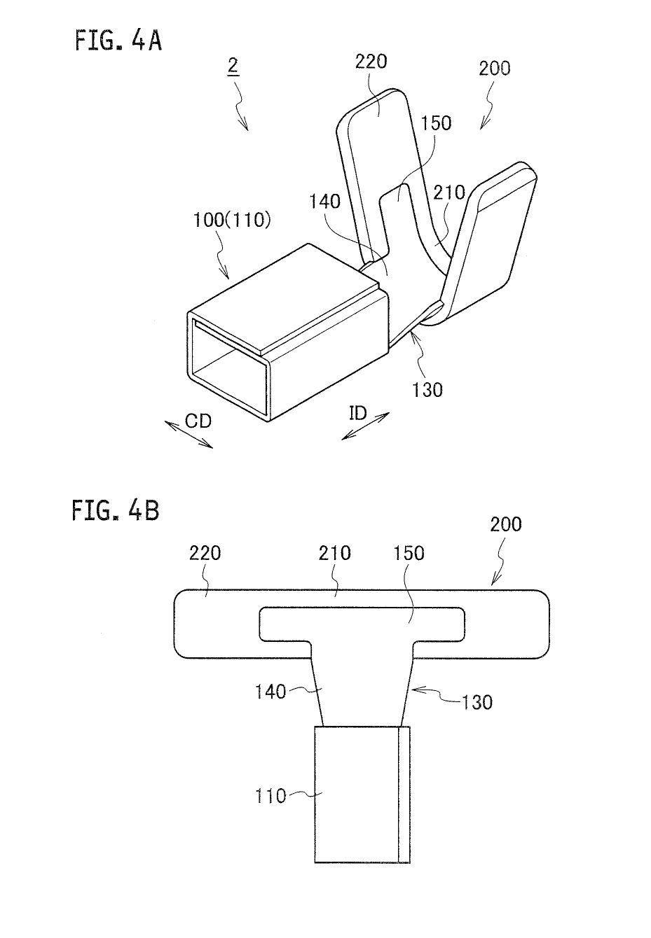

The configuration of the female terminal 2 according to the second embodiment will be described with reference to the accompanying drawings. FIG. 4A is a perspective view illustrating the female terminal 2 according to the second embodiment. FIG. 4B is a partly developed plan view illustrating the female terminal 2 according to the second embodiment.

FIGS. 4A to 12B omit the elastic contact member 120 (elastic contact piece 121) and schematically illustrate the shape of terminal connection portion 100 (body portion 110).

The fixing portion 130 according to the first embodiment has an approximately constant width in the orthogonal direction CD. By contrast, as illustrated in FIGS. 4A and 4B, the fixing portion 130 according to the second embodiment does not have a constant width in the orthogonal direction CD.

Specifically, the fixing portion 130 is T-shaped according to the developed plan view. The fixing portion 130 includes a bottom surface connection portion 140 and a wide end portion 150. The bottom surface connection portion 140 is continuous with the bottom surface 112 of the body portion 110. The wide end portion 150 is continuous with the bottom surface connection portion 140 and is positioned at the tip of the fixing portion 130.

The bottom surface connection portion 140 is formed to gradually widen toward the wide end portion 150 according to the developed plan view of the fixing portion 130. The wide end portion 150 is wider than the bottom surface connection portion 140 in the orthogonal direction CD orthogonal to the male terminal insertion direction ID.

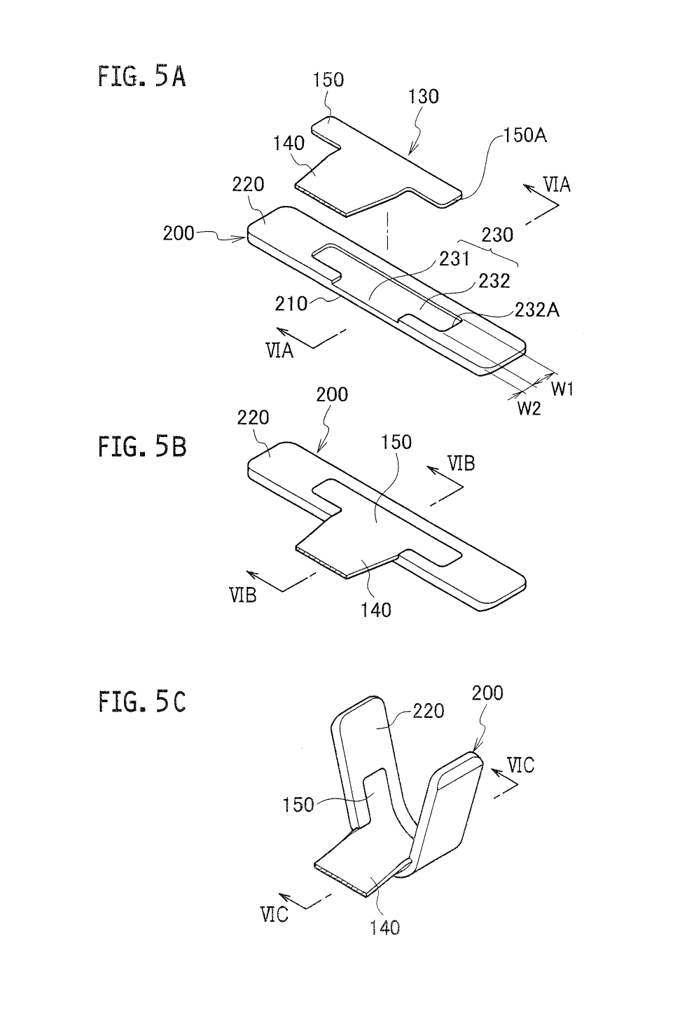

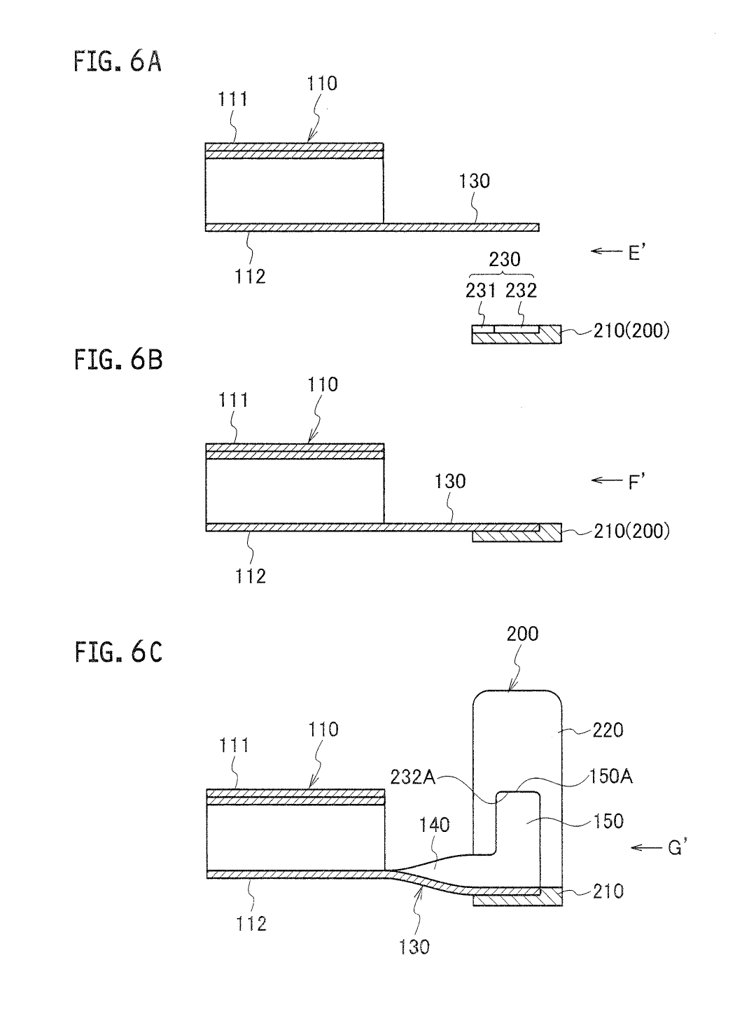

The electric wire connection portion 200 is dented from its surface to form a fitting dent portion 230 (see FIGS. 5A and 6A). The fitting dent portion 230 engages with the fixing portion 130. The depth of the fitting dent portion 230 approximately equals the thickness of the fixing portion 130.

The fitting dent portion 230 is shaped approximately equal to the fixing portion 130 (part of the bottom surface connection portion 140 and the wide end portion 150) according to the developed plan view of the fixing portion 130. Specifically, the fitting dent portion 230 includes a connection dent portion 231 and an end dent portion 232. The connection dent portion 231 engages with the bottom surface connection portion 140. The end dent portion 232 engages with the wide end portion 150. Width W1 of the end dent portion 232 in the male terminal insertion direction ID is greater than width W2 of the electric wire connection portion 200 in the male terminal insertion direction ID.

### (2.2) Fixing the Fixing Portion 130 and the Electric Wire Connection Portion 200

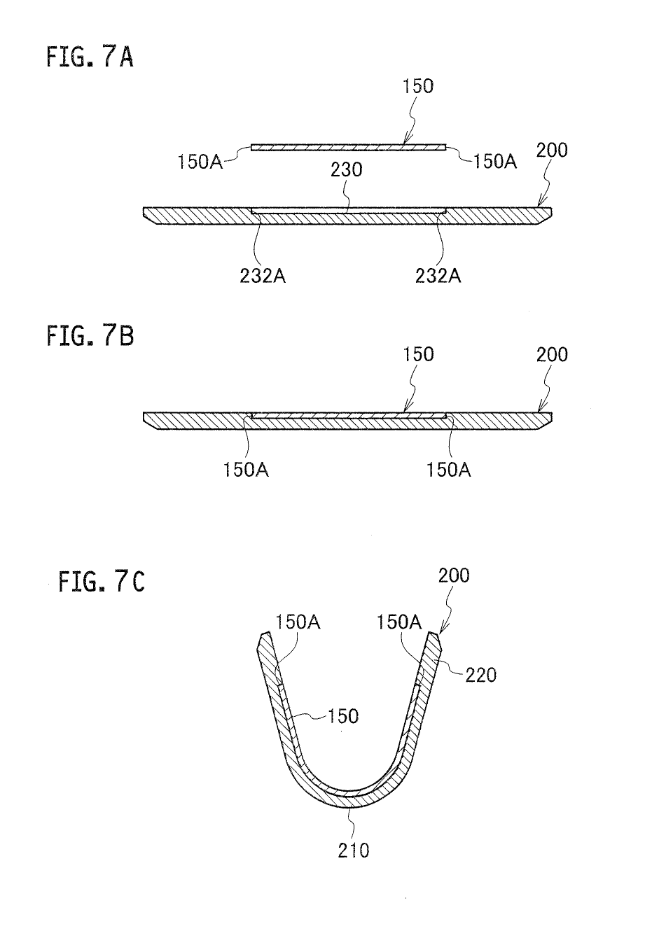

The following describes fixing (fitting) between the fixing portion 130 and the electric wire connection portion 200 with reference to the accompanying drawings. FIG. 5A is a perspective view illustrating a disassembled state of only the fixing portion 130 and the electric wire connection portion 200 according to the second embodiment. FIG. 5B is a perspective view illustrating an assembled state of the fixing portion 130 and the electric wire connection portion 200 according to the second embodiment. FIG. 5C is a perspective view illustrating a bent state of the fixing portion 130 and the electric wire connection portion 200 according to the second embodiment. FIG. 6A is a cross sectional view taken along the line VIA-VIA of FIG. 5A. FIG. 6B is a cross sectional view taken along the line VIB-VIB of FIG. 5B. FIG. 6C is a cross sectional view taken along the line VIC-VIC of FIG. 5C. FIG. 7A illustrates FIG. 6A viewed from the arrow E′. FIG. 7B illustrates FIG. 6B viewed from the arrow F′. FIG. 7C illustrates FIG. 6C viewed from the arrow G′.

As illustrated in FIGS. 5A, 6A, and 7A, the fixing portion 130 and the electric wire connection portion 200 are not bent or curved. As illustrated in FIGS. 5B, 6B, and 7B, the fixing portion 130 is inserted into the fitting dent portion 230 to fit to each other. Specifically, part of the bottom surface connection portion 140 fits into the connection dent portion 231. The wide end portion 150 fits into the end dent portion 232.

As illustrated in FIGS. 5C, 6C, and 7C, the fixing portion 130 and the electric wire connection portion 200 are bent while the fixing portion 130 fits into the fitting dent portion 230. A side edge 150A of the wide end portion 150 stops against a sidewall 232A of the end dent portion 232 and stays there. The fixing portion 130 is bent together with the electric wire connection portion 200 and is not removed from the same. The depth of the fitting dent portion 230 approximately equals the thickness of the fixing portion 130. The fixing portion 130 and the electric wire connection portion 200 are level with each other (see FIGS. 6B and 7B).

### (2.3) Operation and Effect

Similar to the operation and effect of the first embodiment, the first embodiment can improve durability of the electric wire connection portion 200 without an increase in manufacturing cost.

The fixing portion 130 according to the second embodiment includes the wide end portion 150. The second embodiment can thereby further enlarge a contacting area between the fixing portion 130 and the electric wire connection portion 200 and increase anchorage strength between them.

The second embodiment forms the fitting dent portion 230 in the electric wire connection portion 200 so that the fixing portion 130 fits into the fitting dent portion 230. Even an external vibration (e.g., vehicle vibration) hardly causes slippage between the fixing portion 130 and the electric wire connection portion 200. This can further increase anchorage strength between the fixing portion 130 and the electric wire connection portion 200. In addition, an electric wire crimped by the electric wire connection portion 200 more reliably stays unmoving in the terminal connection portion 100. This can also improve reliability of connection between a male terminal and the elastic contact member 120 conductively connected to the electric wire.

According to the second embodiment, the side edge 150A of the wide end portion 150 stops against the sidewall 232A of the end dent portion 232 and stays there. The invention is not limited thereto. For example, the side edge 150A of the wide end portion 150 may not stop against the sidewall 232A of the end dent portion 232. That is, the end dent portion 232 may leave an allowance. In this case, bending the fixing portion 130 and the electric wire connection portion 200 unfastens the fixing portion 130 from the electric wire connection portion 200. The side edge 150A of the wide end portion 150 bites into an electric wire to improve conductivity between the electric wire and the fixing portion 130.

### (2.4) Modification

The following describes a modification of the female terminal 2 according to the second embodiment with reference to the accompanying drawings. The same reference numerals are used for the mutually corresponding parts in the modification and the female terminal 2 according to the second embodiment. The description below mainly discloses differences from the second embodiment.

### (2.4.1) Configuration of the Female Terminal 2

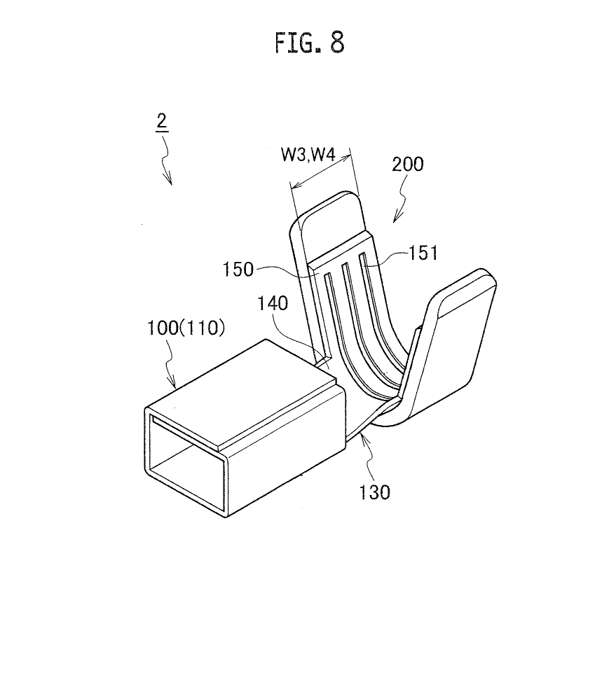

The configuration of the female terminal 2 according to the modification will be described with reference to the accompanying drawings. FIG. 8 is a perspective view illustrating the female terminal 2 according to the modification of the second embodiment.

According to the modification, as shown in FIG. 8, the wide end portion 150 of the fixing portion 130 has width W3 in the male terminal insertion direction ID. The electric wire connection portion 200 has width W4 in the male terminal insertion direction ID. Width W3 approximately equals width W4. One or more raised portions 151 are formed in the wide end portion 150. The raised portions 151 protrude toward the electric wire connection portion 200. Three raised portions 151 are provided parallel to each other in the male terminal insertion direction ID. The raised portions 151 extend in the orthogonal direction CD.

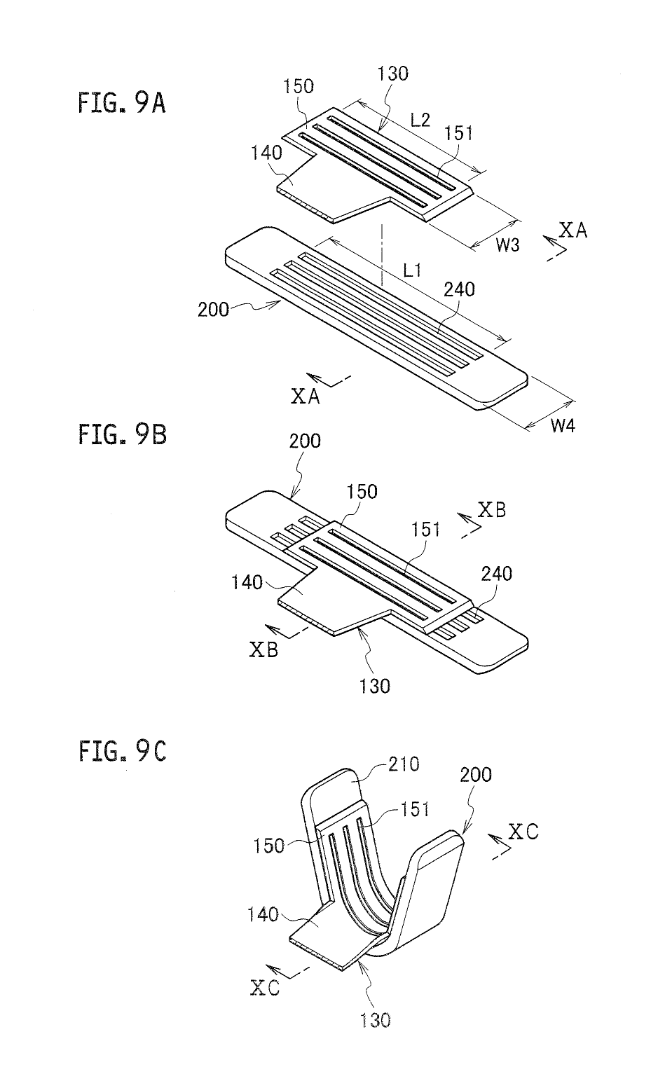

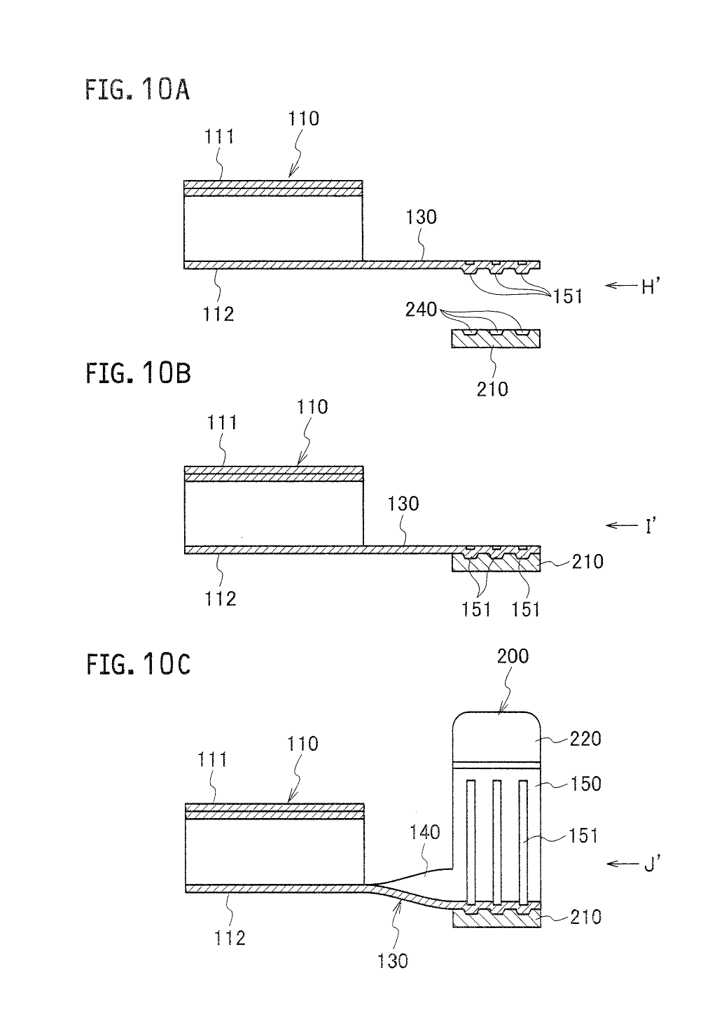

A long groove 240 is formed in the electric wire connection portion 200 (see FIGS. 9A and 10A). The long groove 240 is recessed from the surface of the electric wire connection portion 200 in contact with the fixing portion 130 to the rear side thereof. The raised portion 151 fits into the long groove 240. Three long grooves 240 are provided parallel to each other in the male terminal insertion direction ID. The long grooves 240 extend in the orthogonal direction CD. The long groove 240 has length L1 in the orthogonal direction CD. The raised portion 151 has length L2 in the orthogonal direction CD. Length L1 is longer than length L2.

### (2.4.2) Fixing the Fixing Portion 130 and the Electric Wire Connection Portion 200

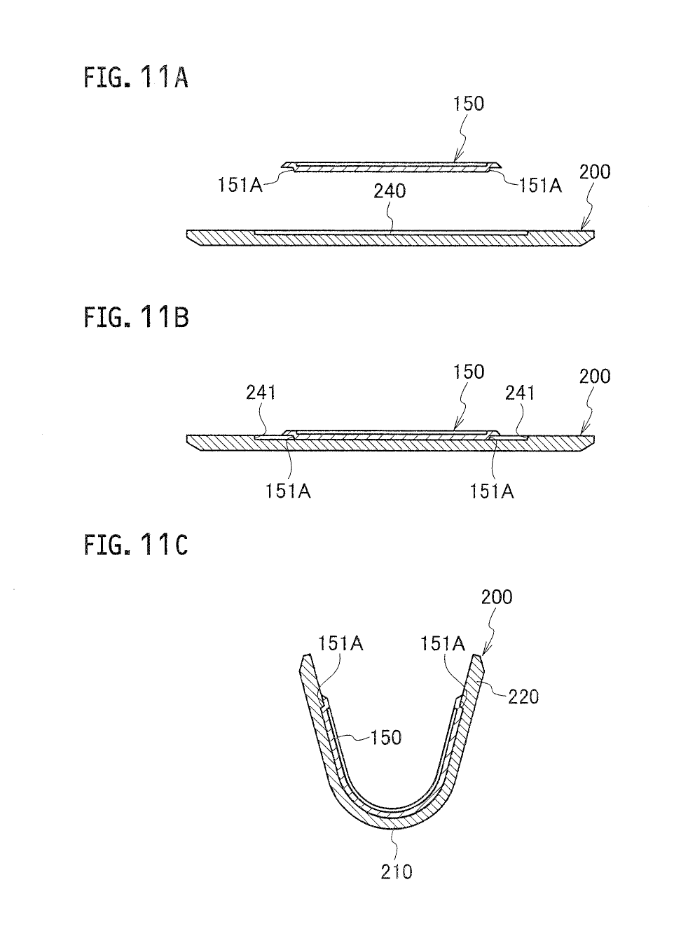

The following describes fixing (fitting) between the fixing portion 130 and the electric wire connection portion 200 with reference to the accompanying drawings. FIG. 9A is a perspective view illustrating a disassembled state of only the fixing portion 130 and the electric wire connection portion 200 according to the second embodiment. FIG. 9B is a perspective view illustrating an assembled state of the fixing portion 130 and the electric wire connection portion 200 according to the second embodiment. FIG. 9C is a perspective view illustrating a bent state of the fixing portion 130 and the electric wire connection portion 200 according to the second embodiment. FIG. 10A is a cross sectional view taken along the line XA-XA of FIG. 9A. FIG. 10B is a cross sectional view taken along the line XB-XB of FIG. 9B. FIG. 10C is across sectional view taken along the line XC-XC of FIG. 9C. FIG. 11A illustrates FIG. 10A viewed from the arrow H′. FIG. 11B illustrates FIG. 10B viewed from the arrow I′. FIG. 11C illustrates FIG. 10C viewed from the arrow J′.

As illustrated in FIGS. 9A, 10A, and 11A, the fixing portion 130 and the electric wire connection portion 200 are not bent or curved. As illustrated in FIGS. 9B, 10B, and 11B, the fixing portion 130 is placed on the electric wire connection portion 200. The raised portion 151 then fits into the long groove 240.

As illustrated in FIGS. 9C, 10C, and 11C, the fixing portion 130 and the electric wire connection portion 200 are bent while the raised portion 151 fits into the long groove 240. A side edge 151A of the raised portion 151 stops against a sidewall 241A of the long groove 240 and stays there. The fixing portion 130 is bent together with the electric wire connection portion 200 and is not removed from the same.

### (2.4.3) Operation and Effect

Similarly to the second embodiment, the modification of the second embodiment can further enlarge a contacting area between the fixing portion 130 and the electric wire connection portion 200 and increase anchorage strength between them. The modification can also improve reliability of connection between a male terminal and the elastic contact member 120 conductively connected to the electric wire.

### (3) Third Embodiment

The configuration of a female terminal 3 according to the third embodiment will be described with reference to the accompanying drawings. The same reference numerals are used for the mutually corresponding parts in the female terminal 3 and the female terminals 1 and 2 according to the first and second embodiments. The description below mainly discloses differences from the first and second embodiments.

### (3.1) Configuration of the Female Terminal 3

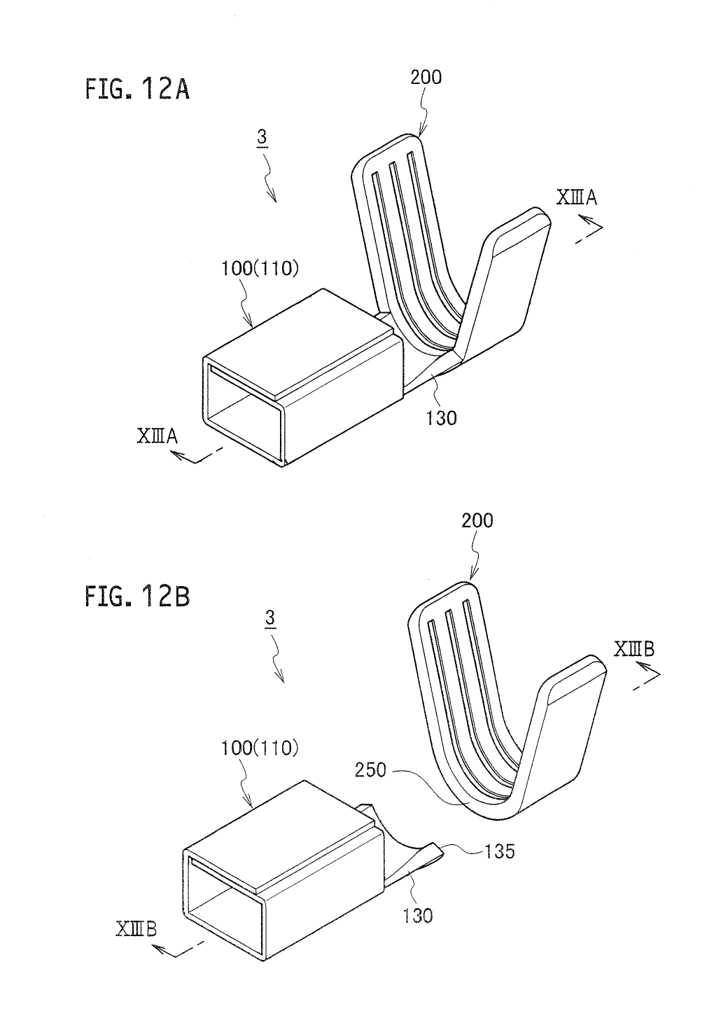

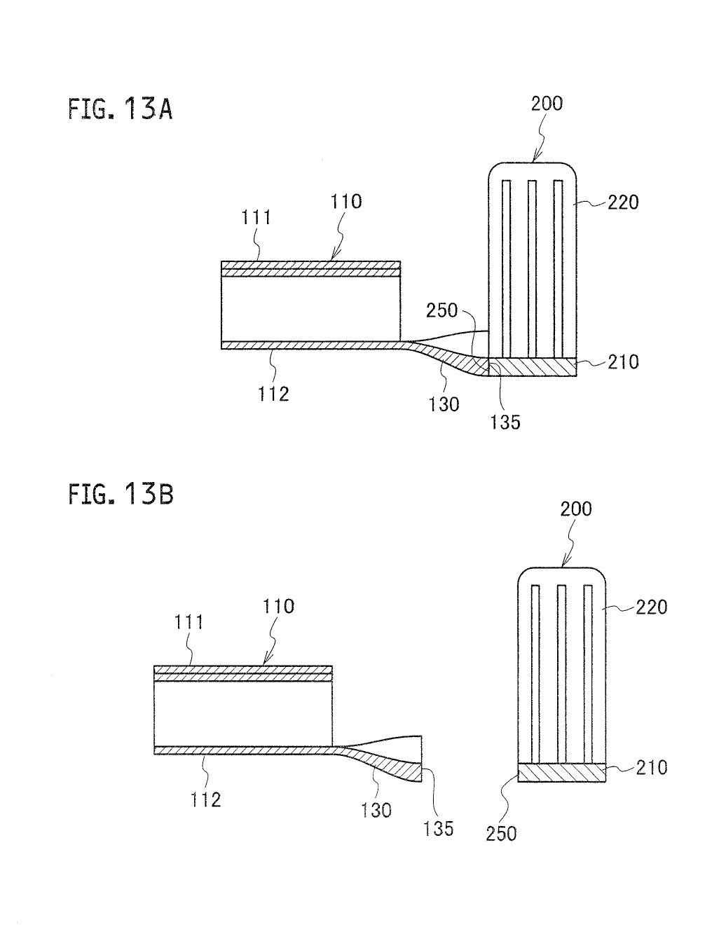

The configuration of the female terminal 3 according to the third embodiment will be described with reference to the accompanying drawings. FIG. 12A is a perspective view illustrating the female terminal 3 according to the third embodiment. FIG. 12B is a disassembled perspective view illustrating the female terminal 3 according to the third embodiment. FIG. 13A is a cross sectional view taken along the line XIIIA-XIIIA of FIG. 12A. FIG. 13B is a cross sectional view taken along the line XIIIB-XIIIB of FIG. 12B.

According to the first and second embodiments, the contact surface 131 of the fixing portion 130 contacts with the electric wire connection portion 200 and is fixed to it. By contrast, according to the third embodiment, an edge portion 135 of the fixing portion 130 contacts with the electric wire connection portion 200 and is fixed to it.

Specifically, as illustrated in FIGS. 12A, 12B and 13A, 13B, the fixing portion 130 includes the edge portion 135. The edge portion 135 protrudes from the terminal connection portion 100 nearest to the electric wire connection portion 200. The edge portion 135 is fixed to an edge 250 of the electric wire connection portion 200 through solid-phase bonding or welding.

The solid-phase bonding is a generic term for welding methods for bonding solidus surfaces as bonded surfaces together. The solid-phase bonding welds a weld (welded joint) on the solidus surface at the temperature lower than or equal to the melting point of a base material without using a welding material such as brazing filler metal. The solid-phase bonding includes pressure welding and non-pressurized welding. For example, the solid-phase bonding includes various types of pressure welding such as friction pressure welding, forge welding, diffusion bonding, hot pressure welding, cold welding (cold pressure welding), explosive welding, and gas-pressure welding.

### (3.2) Operation and Effect

Similar to the operation and effect of the first and second embodiments, the third embodiment can improve durability of the electric wire connection portion 200 without an increase in manufacturing cost.

According to the third embodiment, the edge portion 135 is fixed to the electric wire connection portion 200 through solid-phase bonding or welding. This can minimize the amount of fixing portion 130 protruding from the terminal connection portion 100 and save the base material for the fixing portion 130. The embodiment can further reduce manufacturing cost of the female terminal 3.

### (4) Other Embodiments

While there have been disclosed specific embodiments of the present invention, it is to be distinctly understood that the present invention is not limited to the description and drawings included in the disclosure. According to the disclosure, those skilled in the art will appreciate various alternative embodiments, examples, and operational technologies.

For example, the embodiments of the invention may be modified as follows. While it has been described that the contact surface 131 and the surface 132 of the fixing portion 130 are indented, the invention is not limited thereto. For example, the surfaces may be dimpled or may not be indented.

Similarly, while it has been described that the surfaces of the bottom portion 210 and the crimping portion 220 of the electric wire connection portion 200 are indented, the invention is not limited thereto. For example, the surfaces may be dimpled or may not be indented.

While it has been described that the fixing portion 130 is fixed to the electric wire connection portion 200 before bending, the invention is not limited thereto. The fixing portion 130 may be fixed to the electric wire connection portion 200 after bending.

While it has been described that the fixing portion 130 is formed integrally with the body portion 110 (bottom surface 112), the invention is not limited thereto. The fixing portion 130 may be formed independently of the body portion 110. For example, the fixing portion 130 may be formed integrally with the elastic contact member 120.

While it has been described that the elastic contact member 120 is formed integrally with the body portion 110, the invention is not limited thereto. The elastic contact member 120 may be formed independently of the body portion 110.

Although the present invention has been described above by reference to the embodiments, the present invention is not limited to those and the configuration of parts can be replaced with any configuration having a similar function.

What is claimed is:

1. A female terminal comprising:
a terminal connection portion for a male terminal to be inserted, the terminal connection portion being provided along a surface extending in an insertion direction of the male terminal to be inserted into the terminal connection portion; and
an electric wire connection portion for connection with an electric wire to be electrically connected to the male terminal, the electric wire connection portion being formed independently of the terminal connection portion and having a plate shape with a thickness greater than a thickness of a base material of the terminal connection portion,
wherein the terminal connection portion comprises a fixing portion for the electric wire connection portion to be fixed.

2. The female terminal according to claim 1, wherein
the terminal connection portion comprises:
a box-shaped body portion; and
an elastic contact member built into the body portion and being contactable with the male terminal, and
the fixing portion is formed integrally with the body portion or the elastic contact member.

3. The female terminal according to claim 1, wherein
the electric wire connection portion comprises:
a bottom portion for positioning a core of the electric wire; and
a crimping portion continuous with the bottom portion and raised from the bottom portion, and
the fixing portion protrudes toward the electric wire connection portion and has a contact surface configured to contact with a surface of the bottom portion located inward of the crimping portion.

4. The female terminal according to claim 1, wherein the fixing portion comprises:
a connection portion continuous with a surface extending in the insertion direction of the male terminal to be inserted into the terminal connection portion; and
a wide end portion positioned at a tip of the connection portion and formed wider than the connection portion in a direction orthogonal to the insertion direction of the male terminal.

5. The female terminal according to claim 1, wherein the fixing portion and the electric wire connection portion are indented.

6. The female terminal according to claim 1, wherein the electric wire connection portion comprises a fitting dent portion formed by denting from a surface of the electric wire connection portion and configured to fit to the fixing portion.

7. The female terminal according to claim 1, wherein
the fixing portion comprises an insertion hole,
the electric wire connection portion comprises a projection portion protruding from a surface of the electric wire connection portion, the projection portion being to be inserted into the insertion hole and thereafter be deformed at a tip thereof to fix the fixing portion to the electric wire connection portion.

8. The female terminal according to claim 1, wherein
the fixing portion comprises an edge portion protruding from the terminal connection portion nearest to the electric wire connection portion, and
the edge portion is fixed to an edge of the electric wire connection portion through solid-phase bonding or welding.
